(19) United States
(12) Patent Application Publication
(10) Pub. No.: US 2018/0304294 A1
(43) Pub. Date: Oct. 25, 2018

(54) METHOD AND DEVICE FOR MASKING SECURING HOLES IN RIMS

(71) Applicant: EISENMANN SE, Boeblingen (DE)

(72) Inventors: Eckhard Riemrich, Rottenburg (DE); Roland Steck, Filderstadt (DE)

(21) Appl. No.: 15/765,388

(22) PCT Filed: Sep. 6, 2016
(86) PCT No.: PCT/EP2016/070948

§ 371 Date: Apr. 2, 2018

(30) Foreign Application Priority Data
Oct. 9, 2015 (DE) 10 2015 013 117.6

(51) Int. Cl. B05B 12/30

(52) U.S. Cl. CPC B05B 12/30; B05D 1/32

(57) ABSTRACT

A method for masking securing holes of rims, which are moved on a transport device of a rim-coating system, wherein the method includes the step of determining the position and number of non-masked securing holes. A first non-masked securing hole of a rim is approached, and the first non-masked securing hole is masked with a first masking element by means of a manipulation device. Only in the subsequent step is a second non-masked securing hole of the same rim approached, and the second non-masked securing hole is masked with a second masking element by means of the manipulation device.

### BACKGROUND OF THE INVENTION

### 1. Field of the Invention

The invention relates to a method for masking securing holes in rims before the rims are painted or coated in some other way. The invention furthermore relates to a device suitable for carrying out the method.

### 2. Description of the Prior Art

From the prior art it is known that rims of the kind provided, in particular, for use on vehicles can be produced from metallic materials, such as steel or aluminum. Rims of this kind are provided with a coating comprising one or more layers. The coating serves as corrosion protection for the metallic material and often also to improve the aesthetic effect of the vehicle wheels. Wet painting methods and powder coating methods are usually used as coating methods for the vehicle wheels, and these methods can also be combined.

The rim has holes by means of which the rim can be secured on an end flange of a vehicle axle. A first group of holes is formed by securing holes such as wheel bolt holes, which have contact surfaces for the heads of the wheel bolts. A rim furthermore generally has a central hole, which is used to center the rim in relation to the wheel axle and can receive a hub cap. In contrast to the remaining surface areas of the rim, the securing holes should be at least substantially free from coating after the coating of the rim has been carried out. This ensures, in particular, that the matching geometry between the wheel bolt and the rim in the region of the contact surface can provide the required frictional engagement during operation. If there is any coating remaining in the region of the contact surface, the surface pressure between the wheel bolt and the rim changes, particularly owing to settling processes, and this could impair operational safety.

There is a known practice in the prior art of masking the functional surfaces for the duration of the coating processes in order to prevent coating material hitting said surfaces and adhering there. For this purpose, masking elements, such as balls or plugs, are placed on the securing holes, thereby sealing them, by means of a manipulation unit, which can be designed as a robot for example, before coating is carried out. The robot is equipped with a multiple gripper as a tool, the gripping units of which are rigidly arranged to match the pattern of the securing holes in the rim. Thus, a multiple gripper of this kind can only be used for one rim type. If the intention is to mask rims of different types on a coating system, multiple grippers matched to the rim types must be made available to the robot, and this is associated with high system costs. Moreover, it is only possible to change the rim types on such coating systems after changing the multiple gripper. The tool changing times required for this purpose reduce the throughput of the coating system.

### SUMMARY OF THE INVENTION

It is an object of the invention to provide a method which allows flexible masking of securing holes in different rim types and which can be operated at lower cost. It is furthermore an object of the invention to provide a device which is suitable for carrying out a method of this kind and is constructed from a particularly small number of components.

In respect of the method, this object is achieved by a method for masking securing holes in rims which are being moved on a transfer unit of a rim-coating system, wherein the method comprises the following steps:
a) determining the position and number of non-masked securing holes;
b) a first non-masked securing hole in a rim is approached, and the first non-masked securing hole is masked with a first masking element by means of a manipulation unit, and
c) a second non-masked securing hole in the same rim is approached, and the second non-masked securing hole is masked with a second masking element by means of the manipulation unit,
   wherein steps b) and c) are carried out in succession.

The invention is based on the insight that rims with almost any pattern of securing holes can be masked if each non-masked securing hole can be approached and masked individually. It is thereby possible to simultaneously process different rim types on the same coating system without changing tools. This contributes to a reduction in system and process costs. Such a method can be adapted with significantly greater flexibility to the current demand on the coating system.

Although, according to the invention, the securing holes can be approached and masked individually, no more time, and generally indeed less time, is required to mask all the securing holes in a rim. Here, use is made of the fact that manipulation units which can move small masses with a very high traversing speed and precision are now available. Delta robots are particularly suitable as manipulation units. This is taken to mean a robot with parallel kinematics which has three or four parallel axes and is distinguished by particularly high speed and very good reproducibility. As an alternative, it is also possible to use an articulated arm robot as a manipulation unit. In contrast, the manipulation units used in the prior art require a large support, on which the grippers are secured in accordance with the pattern of securing holes. A support of this kind with a plurality of grippers mounted at relatively large intervals thereon can be moved only relatively slowly with high precision.

To determine the position and number of non-masked securing holes in step a), an image recorded by a camera can be evaluated. As an alternative, a thermal imaging camera or a laser scanning system can be used. The pitch circle diameter and the absolute or relative vertical position of the securing holes can be evaluated as position information, for example. A pitch circle is taken to mean a circle which is arranged concentrically with the center of the rim and on which the centers of the wheel bolt holes are arranged. In addition, further data, such as the diameter of the securing holes can be detected.

If rims of different rim types are masked with the method, it can be envisaged that, in step a), the rim type to which a rim fed in by the transfer unit belongs is determined. For this purpose, rim information, such as the rim diameter and, where appropriate, the shape and embodiment of rim spokes, can be detected. Depending on the rim type determined, a masking element matched to the rim type from among a plurality of different masking elements can then be used to mask a securing hole. Here, balls or plugs can be used as masking elements, for example.

Instead of detecting the abovementioned information with a camera or a laser scanning system, at least some of this information can also be obtained by reading out an information carrier arranged on the rim with the aid of a data exchange device. This information can furthermore be made available by a higher-level system controller of the device.

In one illustrative embodiment of the method, the manipulation unit has precisely one gripper, which is designed to pick up the masking elements. Before step b), the manipulation unit picks up the first masking element from an element store. Between step b) and step c), i.e. before the second securing hole is approached, the manipulation unit picks up the second masking element from the same element store or a different element store. Since the manipulation unit has only one gripper, it is possible to achieve very rapid traversing movements. A pneumatically operated suction device, which can be a very simple construction, is preferably used as a gripper. As an alternative, a mechanical or magnetic gripper can be used.

By way of example, the element store can be embodied as a turntable which is populated externally with the exact number of masking elements required within a certain time window. Alternatively, it is possible to provide an element store of “arbitrary size”, which, for example, is embodied as a “vibratory conveyor”, from which the masking elements are taken.

In another illustrative embodiment, the manipulation unit has two grippers, which are designed to pick up the masking elements. Before step b), the manipulation unit picks up the first and the second masking element. At least when the additional gripper with the masking element picked up thereby does not decisively increase the weight to be moved by the manipulation unit, this allows a shortening of the traversing paths and thus of the process time required for the masking of the securing holes in a single rim. If, on the other hand, the additional weight becomes too great, the traversing times may even be increased. Corresponding considerations apply to manipulation units with three or more grippers.

Moreover, provision can be made for the masking elements to be held by different element stores. In particular, this is advantageous if the different element stores are arranged at different locations along the conveying direction, for example, ensuring that there is always an optimum element store with a minimum traversing path for the manipulation unit for a rim moving past the element stores.

To further shorten traversing paths of the manipulation unit between the element store and the securing holes, provision can furthermore be made for the element store to be moved in the direction of the rim before the masking elements are picked up. Active element stores of this kind can be employed both when using individual grippers and when using multiple grippers.

If furthermore different rim types are masked with the device, it may be advantageous, in particular, if the element store is moved in the direction of the rim in a manner dependent on the rim type before the masking elements are picked up. It is thereby possible to optimize the traversing path in accordance with the rim type.

In another illustrative embodiment of the method, it is envisaged that the manipulation unit comprises at least two grippers of different designs, which are designed to grip masking elements of different designs. The grippers can be arranged on the manipulation unit by means of a turret head and can be rotatable about a turret axis, for example, ensuring that only one gripper masks a securing hole in the rim at a particular point in time.

In another illustrative embodiment of the method, it is furthermore envisaged that at least two mutually independent manipulation units mask securing holes in the same rim with masking elements. By virtue of this division of labor, the masking of a rim may take place at a speed which is up to twice as great, thus allowing the throughput of the device to be doubled in corresponding fashion. Because of the continuous traversing movement of the rims on the transfer unit, this procedure is more advantageous than if the manipulation units completely mask each of the rims in alternation.

In respect of the device, the object stated at the outset is achieved by a device for masking securing holes in rims which are being moved on a transfer unit of a rim-coating system, wherein the device comprises a workpiece detection unit, which is configured to determine the position and number of non-masked securing holes. According to the invention, it is envisaged that the device furthermore comprises a manipulation unit, which is configured
to approach a first non-masked securing hole in a rim and to mask it with a first masking element, and, with a time delay relative thereto,
to approach a second non-masked securing hole in the same rim and to mask it with a second masking element.

In this context, a camera and/or a data exchange device can be provided as a workpiece detection unit.

The device can have precisely one gripper, which is designed to pick up the masking elements, and can have a controller which is configured to control the manipulation unit in such a way that the manipulation unit
a) picks up the first masking element from an element store before it approaches and masks the first securing hole, and
b) picks up the second masking element from the same or a different element store after the first securing hole has been masked.

As an alternative, provision can be made for the manipulation unit to have two grippers, which are designed to pick up the masking elements, and for the device to have a controller which is configured to control the manipulation unit in such a way that the manipulation unit picks up the first masking element from one element store and picks up the second masking element from the same or a different element store before it approaches the first and the second securing hole.

Provision can furthermore be made to enable the masking elements to be picked up from different element stores. The device can have a controller which is configured to control movements of the element store in such a way that the element store is moved in the direction of the rim before the masking elements are picked up.

In one illustrative embodiment, provision is made for the device to be configured to mask rims of different rim types and for the workpiece detection unit to be configured to determine the rim type to which a rim fed in by the transfer unit belongs. To determine the rim type, there is the possibility here of enabling an image of the rim fed in, recorded by the camera as a workpiece detection unit, to be evaluated. As an alternative, it is also possible for data to be read out of an information carrier by means of a data exchange device.

Provision can furthermore be made for the device to have a controller which is configured to control the manipulation unit in such a way that, depending on the rim type determined, a masking element matched to the rim type from among a plurality of different masking elements is used to mask a securing hole.

In particular, provision can be made for the device to have a controller which is configured to control movements of the element store in such a way that the element store is moved in the direction of the rim in a manner dependent on the rim type before the masking elements are picked up.

In another illustrative embodiment, provision is made for the manipulation unit to comprise at least two grippers of different designs, which are designed to grip masking elements of different designs.

In another illustrative embodiment, provision is made for the device to comprise at least two mutually independent manipulation units and for the device to have a controller which is configured to control the two manipulation units in such a way that both manipulation units mask securing holes in the same rim with masking elements.

According to another aspect of the invention, the object stated at the outset is achieved in respect of the device by a device for masking securing holes in rims, which are being moved on a transfer unit of a rim-coating system, which device comprises a workpiece detection unit, which is configured to determine the position and number of non-masked securing holes. According to the invention the device furthermore comprises a manipulation unit which has no more than two grippers, which are configured to grab masking elements designed to mask the securing holes.

The manipulation unit preferably comprises precisely one gripper, by means of which it approaches and masks the securing holes in the rim individually.

### BRIEF DESCRIPTION OF THE DRAWINGS

Illustrative embodiments of the invention are explained in greater detail below with reference to the drawings, in which:

FIG. 1 shows a plan view of various rim types with non-masked securing holes, which are being moved on a transfer unit of a rim-coating system;

FIG. 2 shows a front view of a device for masking securing holes in rims in accordance with a first illustrative embodiment of the invention;

FIG. 3 shows a view in the conveying direction of the device shown in FIG. 2;

FIG. 4 shows a view in the conveying direction of a device in accordance with the second illustrative embodiment of the invention, which has a manipulation unit with a multiple gripper;

FIGS. 5a to 5d show four schematic plan views of a rim, in which different manipulation-unit traversing paths according to the invention are illustrated;

FIG. 6 shows a schematic plan view of a rim and of the traversing path of an element store according to the method according to the invention.

### DESCRIPTION OF PREFERRED ILLUSTRATIVE EMBODIMENTS

1. Basic Construction of the Device

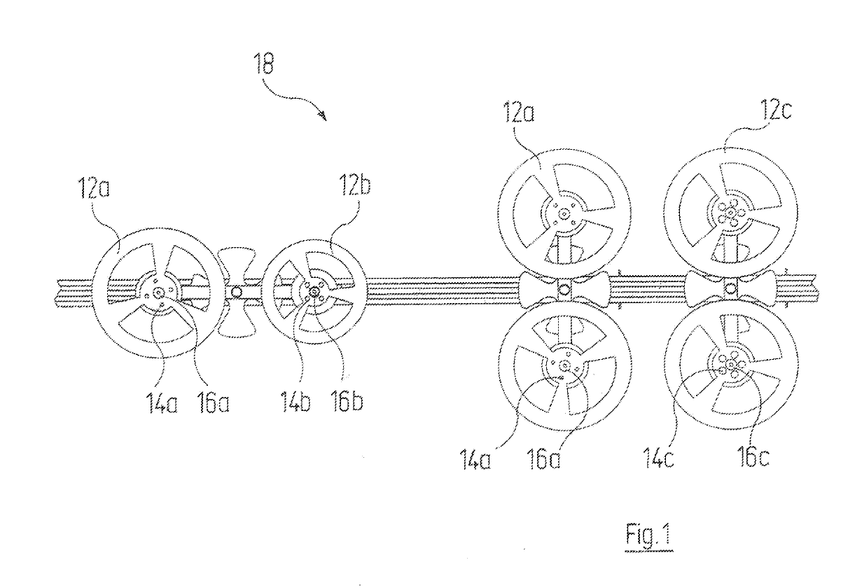

The figures show a masking device, denoted overall by 10, in a coating system, not shown specifically, for rims 12 of vehicles. As shown in FIG. 1, the rims 12 comprise different rim types 12a, 12b and 12c, which differ in diameter and each have securing holes 14 in the form of wheel bolt holes. Depending on the rim type, the securing holes 14a, 14b and 14c differ in number, diameter and pitch circle. A pitch circle is taken to mean a circle which is arranged concentrically with the center of the rim and on which the centers of the wheel bolt holes are arranged.

Furthermore, the rims 12a, 12b, 12c have central hub holes 16a, 16b and 16c, which can differ in diameter depending on the rim type.

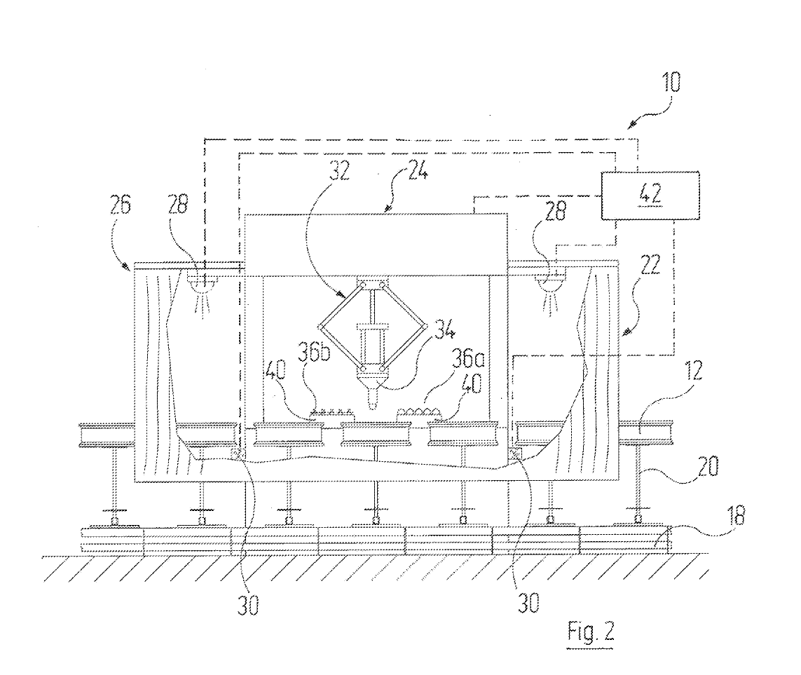

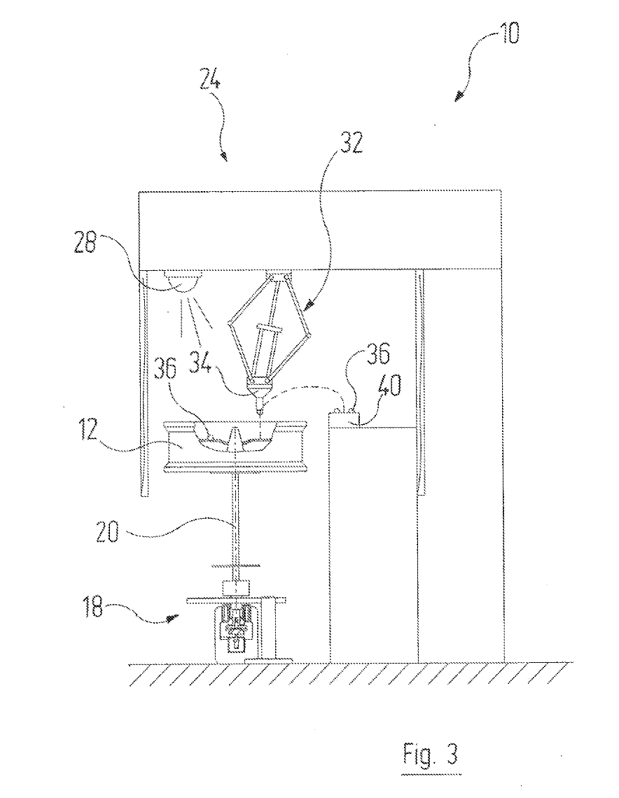

FIG. 2 shows a front view of a first illustrative embodiment of the device 10 according to the invention. The rims 12 are arranged on rotatable spindles 20 of a transfer unit 18 by means of a mandrel 19 which passes through the hub holes 16a, 16b, 16c, as shown in FIG. 3.

The masking device 10 comprises a workpiece detection region 22, a masking region 24 and a checking region 26.

A camera 28 and a data exchange device 30 are arranged in both the workpiece detection region 22 and the checking region 26. The data exchange device 30 communicates with an information carrier (not shown specifically), which is arranged on the rim 12 or on the spindle 20 holding the rim 12 and stores rim-specific data.

Accommodated in the masking region 24 is a manipulation unit in the form of a robot, in particular a delta robot 32, with which particularly high traversing speeds can be achieved. In the illustrative embodiment shown in FIG. 2, the delta robot 32 has a pneumatically operated individual gripper 34, by means of which it can pick up a masking element. As an alternative, the individual gripper can be operated mechanically or magnetically. FIG. 3 shows a view of the device 10 according to the invention in the conveying direction of the transfer unit 18.

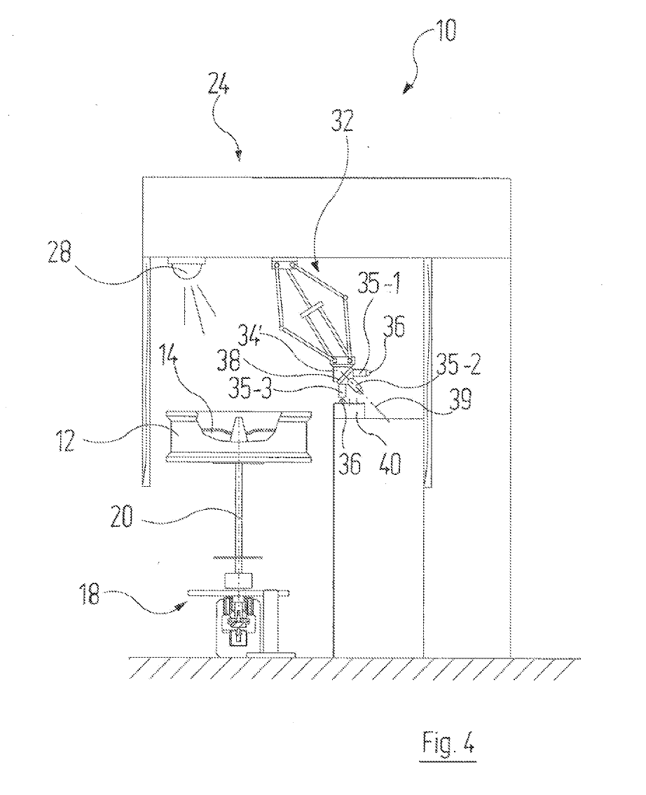

Also shown in FIG. 4 is a delta robot 32, which carries a multiple gripper 34′ having a plurality of gripping units 35-1, 35-2, 35-3. In the illustrative embodiment under consideration, these are arranged on a turret head 38 and are thus mounted in such a way as to be rotatable about a central turret axis 39. When the turret head 38 is rotated, a different gripping unit comes into use.

Masking elements 36 in the form of balls 36a and plugs 36b are made available in respective element stores in the form of pickup magazines 40 and can be picked up by the individual gripper 34 or by the multiple gripper 34′ of the delta robot 32. The balls 36a and the plugs 36b each comprise different types of ball and plug (not shown specifically), which differ depending on the securing holes.

2. Operation

The way in which the securing holes 14a, 14b, 14c are masked with the aid of the device 10 is explained below with reference to FIGS. 2, 3, 4 and 5.

In the rim-coating system, the rims 12 are fed to the workpiece detection region 28 of the masking device 10 by means of the transfer unit 18. By means of the camera 28, data such as the rim diameter, the number of securing holes, the diameter of the securing holes, the pitch circle diameter of the securing holes and the position of the securing holes in relation to the conveying direction are determined and transmitted to a control unit 42 of the device. In addition, data exchange takes place by means of the data exchange device 30 between the control unit 42 of the device 10 and the rim 12 fed in. During this process, for example, information is transferred as to whether a ball 36a or a plug 36b should be made available as a masking element 36 for the rim 12. If unambiguous recognition of the rim 12 can be achieved by means of the camera 28 alone, it is possible to dispense with the data exchange device 30.

The rim 12 is then fed to the masking region 24 without interruption to the conveying movement. While the rim 12 is being conveyed onward on the transfer unit 18, the required masking elements 36 are made available to the pickup magazines. During this process, the rim 12 is preferably moved with only one degree of freedom, namely in the conveying direction, at a predetermined conveying speed. In this way, the control unit 42 of the device can calculate at any time the position data of the securing holes 14 to be masked from the data transmitted by the camera 28. If there is nevertheless rotation of the rim 12, a dynamic offset is calculated from the movement parameters of the spindle 20 and transmitted to the control unit 42 of the device 10, the position data determined being corrected by means of said offset. As an alternative, the delta robot 32 carries an additional camera (not shown specifically), which is only used to determine the position of a free securing hole when there is unwanted rotation of the rim 12. In this case, however, this camera represents an additional load for the delta robot 32, which could impair the dynamic characteristics. This could be prevented by an additional, stationary camera.

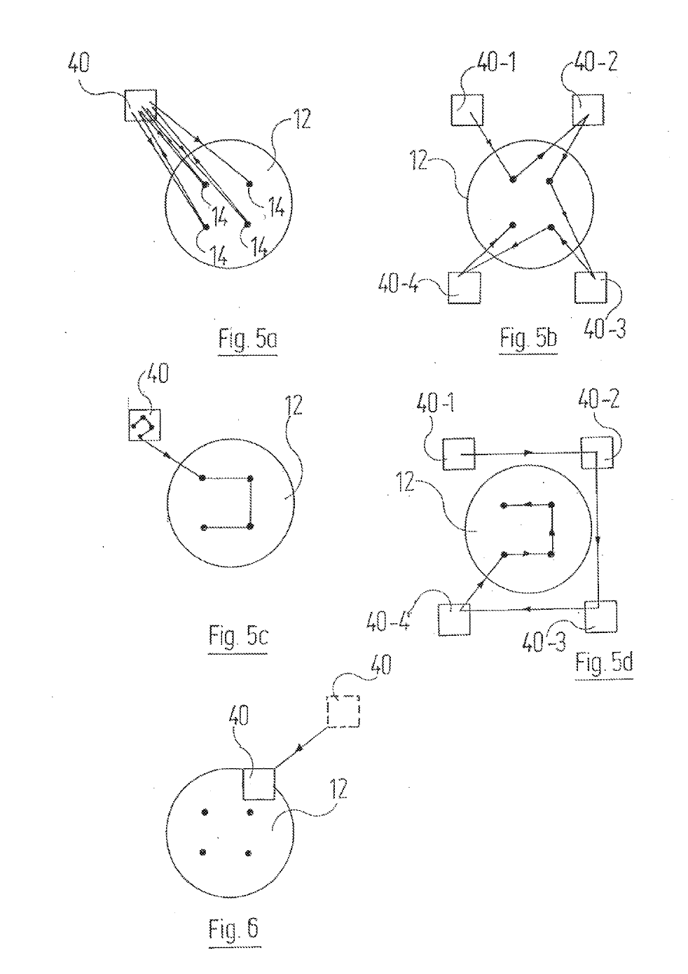

In the next step, the delta robot 32 masks the non-masked securing holes 14. In the illustrative embodiment shown in FIG. 2, in which the delta robot 32 is equipped with an individual gripper 34, masking takes place in accordance with the schematic illustration in FIG. 5a. In this process, the delta robot 32 first of all picks up a first masking element 36, e.g. a ball 36a, from a pickup magazine 40. After this, the delta robot 32 approaches a first non-masked securing hole 14 of the rim 12 fed in and masks said hole with the first masking element 36 picked up by placing the masking element 36 on the securing hole 14, with the result that the masking element covers the securing hole 14. This prevents coating material being able to penetrate into the securing hole 14 and being deposited there in a subsequent coating process. After masking, the delta robot 32 approaches the same pickup magazine 40 and picks up the second masking element 36 from the same pickup magazine 40. The delta robot 32 then approaches the second non-masked securing hole 14 in the same rim and masks it with the second masking element 36 picked up. All the other securing holes 14 in the rim 12 are masked in the same way.

FIG. 5b shows schematically an illustrative embodiment of the device 10 in which a plurality of different pickup magazines 40-1, 40-2, 40-3, 40-4 is arranged around the rim 12. In this case, the same or different masking elements can be made available to the pickup magazines 40-1, 40-2, 40-3, 40-4, depending on requirements. The masking of the securing holes 14 in a rim 12 with the same masking elements 36, e.g. balls 36a, is performed in such a way that a new masking element 36 is in each case picked up from a different pickup magazine by the individual gripper 34 between the approach to and masking of each wheel bolt hole 14. In this case, the arrangement of the pickup magazines 40-1, 40-2, 40-3, 40-4 along the device is matched in such a way to the rim type of the rim 12 and to the conveying speed of the transfer unit 18 that the delta robot 32 travels minimum traversing paths overall, thereby ensuring a high processing speed.

If, as an alternative, the delta robot 32 is equipped with a multiple gripper 34′, as shown in FIG. 4, the masking of the securing holes 14 in a rim 12 can take place in accordance with the schematic illustration in FIG. 5c for the case of one pickup magazine 40 and in accordance with the schematic illustration in FIG. 5d for the case of a plurality of pickup magazines 40-1, 40-2, 40-3, 40-4, for example. In this case, each of the gripping units picks up one masking element 36 from one or more pickup magazines 40, 40-1, 40-2, 40-3, 40-4 until all the required masking elements 36 have been picked up. The non-masked securing holes 14 in the rim 12 are then approached individually one after the other and each masked with a masking element 36. As long as the multiple gripper 34′ is carrying masking elements 36, the securing holes 14 are approached and masked without further masking elements 36 being taken from the pickup magazine in between. In this way, it is possible to reduce the traversing path of the delta robot 32 as compared with an individual gripper 34.

FIG. 6 shows schematically another illustrative embodiment of the device 10, in which an active pickup magazine 40′ is moved in the direction of the rim 12 before the masking elements 36 are picked up. A dashed line indicates a storage position and a solid line indicates a pickup position of the pickup magazine 40′. In the pickup position illustrated, the pickup magazine is arranged above the rim 12 but, as an alternative, a pickup position at the same height to the side of the rim 12 can also be advantageous. The pickup position is determined in accordance with the rim type determined, wherein the height or the outside diameter of the rim 12 is taken into account, for example. If the movement of the pickup magazine 40′ is matched to the conveying movement of the transfer unit 18 in such a way that the directions of movement and speeds of the pickup magazine 40′ and of the rim 12 are approximately equal during masking, it is possible to significantly reduce the traversing path of the delta robot 32, especially in the case of an individual gripper 34.

In another illustrative embodiment (not shown), the device 10 comprises a further delta robot, which operates parallel and adjacent to the first delta robot 32 in the conveying direction or behind said robot in the conveying direction. The two delta robots are controlled in such a way that they mask securing holes 14 in the same rim 12 with masking elements 36. By means of this division of labor of the masking, each individual rim 12 is completely masked more quickly, thereby enabling the conveying speed and hence the throughput of the device 10 to be increased further.

At the outlet of the device 10, a check is made by means of the camera 28 in the checking region 26 whether or not there are still non-masked securing holes 14. In this case, image processing of the camera 28 in the checking region 26 can be performed more easily than in the workpiece detection region 22. If a rim 12 is recognized as defective, this is indicated by modifying the data record of the rim 12 on the information carrier (not shown specifically) by means of the data exchange device 30. A rim 12 of this kind is subsequently picked out and the non-masked securing hole 14 thereof is masked manually or by another robot in an additional step.

What is claimed is:

1. A method for masking securing holes in rims which are being moved on a transfer unit of a rim-coating system, the method comprising the following steps:
a) determining a position and a number of non-masked securing holes; and
b) approaching a first non-masked securing hole in a rim and masking the first non-masked securing hole with a first masking element by means of a manipulation unit, and
c) approaching a second non-masked securing hole in the same rim and masking the second non-masked securing hole with a second masking element by means of the manipulation unit,
wherein steps b) and c) are carried out in succession.

2. The method as claimed in claim 1, wherein the manipulation unit has precisely one gripper which is designed to pick up the masking elements, wherein the manipulation unit picks up the first masking element from an element store before approaching the first non-masked securing hole, and the manipulation unit picks up the second masking element from the same element store or a different element store after masking the first non-masked securing hole and before approaching the second non-masked securing hole.

3. The method as claimed in claim 1, wherein the manipulation unit has two grippers which are designed to pick up the first and second masking elements, wherein the manipulation unit picks up the first and the second masking elements before approaching the first non-masked securing hole.

4. The method as claimed in claim 1, wherein the element store is moved in a direction of the rim before the masking elements are picked up.

5. The method as claimed in claim 1, wherein rims of different rim types are masked, and the rim type to which a rim fed in by the transfer unit belongs is determined when determining the position and number of non-masked securing holes.

6. The method as claimed in claim 5, wherein depending on the rim type determined, a masking element matched to the rim type from among a plurality of different masking elements is used to mask a securing hole.

7. The method as claimed in claim 4, wherein rims of different rim types are masked, and the rim type to which a rim fed in by the transfer unit belongs is determined when determining the position and number of non-masked securing holes, and the element store is moved in the direction of the rim in a manner dependent on the rim type before the masking elements are picked up.

8. The method as claimed in claim 1, wherein the manipulation unit comprises at least two grippers of different designs, the at least two grippers being designed to grip masking elements of different designs.

9. A device for masking securing holes in rims which are being moved on a transfer unit of a rim-coating system, the device comprising:
a workpiece detection unit which is configured to determine a position and a number of non-masked securing holes, and
manipulation unit, which is configured
to approach a first non-masked securing hole in a rim and to mask it with a first masking element, and, with a time delay relative thereto,
to approach a second non-masked securing hole in the same rim and to mask it with a second masking element.

10. The device as claimed in claim 9, further comprising a controller, wherein the manipulation unit has precisely one gripper which is designed to pick up the first and second masking elements and controller is configured to control the manipulation unit in such a way that the manipulation unit
a) picks up the first masking element from an element store before it approaches and masks the first non-masked securing hole, and b) picks up the second masking element from the same or a different element store after the first non-masked securing hole has been masked.

11. The device as claimed in claim 9, further comprising a controller, wherein the manipulation unit has two grippers which are designed to pick up the first and second masking elements and the controller is configured to control the manipulation unit in such a way that the manipulation unit picks up the first masking element from one element store and picks up the second masking element from the same or a different element store before it approaches the first and the second non-masked securing holes.

12. The device as claimed in claim 9, further comprising a a controller, the controller being configured to control movements of the element store in such a way that the element store is moved in the direction of the rim before the first and second masking elements are picked up.

13. The device as claimed in claim 9, the device is configured to mask rims of different rim types, and in that the workpiece detection unit is configured to determine the rim type to which a rim fed in by the transfer unit belongs.

14. The device as claimed in claim 13, further comprising a controller which is configured to control the manipulation unit in such a way that, depending on the rim type determined, a masking element matched to the rim type from among a plurality of different masking elements is used to mask a non-masked securing hole.

15. The device as claimed in claim 12, wherein the device is configured to mask rims of different rim types, and in that the workpiece detection unit is configured to determine the rim type to which a rim fed in by the transfer unit belongs and the controller is configured to control movements of the element store in such a way that the element store is moved in the direction of the rim in a manner dependent on the rim type before the first and second masking elements are picked up.
